(19) United States
(12) Patent Application Publication
(10) Pub. No.: US 2016/0180216 A1
(43) Pub. Date: Jun. 23, 2016

(54) TECHNIQUES FOR ANSWERING USER QUESTIONS BASED ON USER EXPERTISE LEVEL

(71) Applicant: INTERNATIONAL BUSINESS MACHINES CORPORATION, ARMONK, NY (US)

(72) Inventors: CORVILLE O. ALLEN, MORRISVILLE, NC (US); FAHEEM ALTAF, PFLUGERVILLE, TX (US); STEVEN D. CLAY, ROUND ROCK, TX (US); SHUNGUO YAN, AUSTIN, TX (US)

(73) Assignee: INTERNATIONAL BUSINESS MACHINES CORPORATION, ARMONK, NY (US)

(21) Appl. No.: 14/572,897

(22) Filed: Dec. 17, 2014

(51) Int. Cl. G06N 5/02; G06F 17/30; G09B 7/00

(52) U.S. Cl. CPC G06N 5/02; G09B 7/00; G06F 17/30477

(57) ABSTRACT

A technique for responding to user input includes determining an expertise level of a user with a topic of a question presented by the user to a data processing system. The data processing system generates an answer to the question that is based on the expertise level of the user with the topic.

### BACKGROUND

The present disclosure is generally directed to data processing and, more particularly, to a question answering system. Still more specifically, the present disclosure is directed to techniques for answering user questions based on user expertise level.

Watson is a question answering (QA) system (i.e., a data processing system) that applies advanced natural language processing, information retrieval, knowledge representation, automated reasoning, and machine learning technologies to the field of open domain question answering. In general, document search technology receives a keyword query and returns a list of documents, ranked in order of relevance to the query (often based on popularity and page ranking). In contrast, QA technology receives a question expressed in natural language, seeks to understand the question in greater detail than document search technology, and returns a precise answer to the question.

The Watson system reportedly employs more than one-hundred different algorithms to analyze natural language, identify sources, find and generate hypotheses, find and score evidence, and merge and rank hypotheses. The Watson system implements DeepQA™ software and the Apache™ unstructured information management architecture (UIMA) framework. Software for the Watson system is written in various languages, including Java, C++, and Prolog, and runs on the SUSE™ Linux Enterprise Server 11 operating system using the Apache Hadoop™ framework to provide distributed computing. As is known, Apache Hadoop is an open-source software framework for storage and large-scale processing of datasets on clusters of commodity hardware.

The Watson system employs DeepQA software to generate hypotheses, gather evidence (data), and analyze the gathered data. The Watson system is workload optimized and integrates massively parallel POWER7® processors. The Watson system includes a cluster of ninety IBM Power 750 servers, each of which includes a 3.5 GHz POWER7 eight core processor, with four threads per core. In total, the Watson system has 2,880 POWER7 processor cores and has 16 terabytes of random access memory (RAM). Reportedly, the Watson system can process 500 gigabytes, the equivalent of a million books, per second. Sources of information for the Watson system include encyclopedias, dictionaries, thesauri, newswire articles, and literary works. The Watson system also uses databases, taxonomies, and ontologies.

### BRIEF SUMMARY

Disclosed are a method, a data processing system, and a computer program product (embodied in a computer-readable storage device) for answering user questions based on user expertise level.

A technique for responding to user input includes determining an expertise level of a user with a topic of a question presented by the user to a data processing system. The data processing system generates an answer to the question that is based on the expertise level of the user with the topic. The expertise level of the user may be based on feedback received from the user. The feedback may, for example, be based on one or more of the user expanding instruction steps in the answer that are at a lower expertise level than currently assigned to the user, a query language utilized by the user in the question, a profile of the user, online activities of the user, and a query history of the user with the data processing system.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

The above as well as additional objectives, features, and advantages of the present invention will become apparent in the following detailed written description.

### BRIEF DESCRIPTION OF THE DRAWINGS

The description of the illustrative embodiments is to be read in conjunction with the accompanying drawings, wherein:

FIG. 1 is a diagram of an exemplary high performance computing (HPC) cluster that includes a number of nodes configured to answer user questions based on user expertise level according to various aspects of the present disclosure;

FIG. 2 is a diagram of a relevant portion of an exemplary symmetric multiprocessor (SMP) data processing system included in one of the nodes of FIG. 1, according to an embodiment of the present disclosure;

FIG. 3 depicts relevant components of an exemplary question answering (QA) system pipeline;

FIG. 4 depicts relevant components of the exemplary QA system pipeline in additional detail;

FIG. 5 depicts exemplary instruction steps and sub-steps for an exemplary software updating process;

FIG. 6 depicts exemplary instruction steps and other sub-steps for the exemplary software updating process;

FIG. 7 is a flowchart of an exemplary process for processing information sources for answering user questions, according to an embodiment of the present disclosure; and

FIG. 8 is a flowchart of an exemplary process for answering user questions based on user expertise level, according to an embodiment of the present disclosure.

### DETAILED DESCRIPTION

The illustrative embodiments provide a method, a data processing system, and a computer program product (embodied in a computer-readable storage device) for answering user questions based on user expertise level.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined by the appended claims and equivalents thereof.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized. As may be utilized herein, the term ‘coupled’ encompasses a direct electrical connection between components or devices and an indirect electrical connection between components or devices achieved using one or more intervening components or devices. As used herein, the terms ‘data’ and ‘evidence’ are interchangeable.

Conventionally, when a user has sought online help to perform a task (goal), help returned to the user has included a static set of steps for performing the task that have not taken into account experience and/or characteristics of the user. In this case, the help returned may include instruction steps that are either too detailed (such that advanced users are annoyed and find themselves skipping instruction steps that are too basic, which can result in mistakes) or the help returned may include instruction steps that are not detailed enough (such that beginning users are confused by instruction steps that are missing or implied). According to aspects of the present disclosure, techniques are disclosed that ascertain a knowledge level (expertise level) of a user with a topic (for which the user has asked a question) and then provide an answer (to the user question) in the form of instruction steps that are appropriate for the expertise level of the user. The topic may, for example, be determined by applying natural language processing to the question.

In one or more embodiments, a question answering (QA) system is configured to determine (e.g., through learning) what instruction steps associated with a task are required for users with varying expertise levels. For example, a QA system may be configured to determine a knowledge level (e.g., novice, intermediate, expert) of a user that inputs a question into the QA system. A QA system may then provide an answer to a user that includes appropriate instruction steps based on the determined user knowledge level. In various embodiments, a QA system is configured to determine whether instruction steps included in an answer are appropriate for a knowledge level of a user based on, for example, user satisfaction with the answer provided by the QA system.

In general, a set of information within a domain (topic) is navigated by a QA system (in response to a user question) and instruction steps required to achieve a particular task (related to the user question) are presented to a user. In one or more embodiments, a task is located and an expertise level for instruction steps to achieve the task are designated. In at least one embodiment, sub-steps for main steps may be designated based on natural language parsing, analysis, and reasoning. In various embodiments, the sub-steps are evaluated and assigned an expertise level based on the analysis. In one or more embodiments, a step or steps to achieve a sub-task (e.g., corresponding to a main step) are designated based on user expertise level. The user expertise level associated with a step or sub-step is then used when presenting expertise based instruction steps (for performing a task or sub-task) to a user without requiring a subject matter expert (SME) to assign expertise levels. Advantageously, the disclosed techniques facilitate the delivery of concise user level appropriate instruction steps and sub-steps in a dynamic manner.

In general, the disclosed techniques enhance a user experience with a QA system, as documentation for performing a set of instruction steps is personally tailored for a user. For example, mark-up information that designates an expertise level for instruction steps and sub-steps, associated with an answer, may be dynamically adjusted in real-time. Employing user feedback further facilitates fine tuning expertise levels. For example, the disclosed techniques may be employed to advantageously facilitate paring Discovery Advisor™ with Engagement Advisor™ in a contact center environment that presents step-by-step instructions to a user for performing a task.

According to one or more embodiments, a set of documents for a topic is parsed to locate instruction steps to perform a desired task. In at least one embodiment, the instructions steps are annotated for the desired task. Relevant available information may then be searched for similar steps and to determine how often the steps are repeated in the information. A determination may then be made as to which steps are ‘optional’ or ‘conditional’ via statement analysis (e.g., language such as ‘optional’, ‘if’, ‘prerequisite’, etc.), which steps are required (including language such as ‘make sure’, ‘must’, ‘always’, etc.), and the steps may then be annotated accordingly. Instruction steps that achieve a sub-task (i.e., a main step of a task) may be determined by noting repetition of the instruction steps that achieve the sub-task within the information. An expertise level (e.g., novice, intermediate, expert) may then be designated based on, for example, conditionality type descriptors (e.g., optional, required, or normal) and whether the item is a step or a sub-step. In one embodiment, the designation of expertise level is based on the number of occurrences and prevalence of particular instruction steps in searched information or a sub-category of the searched information. In general, as the number of occurrences of a given instruction step increases, a lower expertise level for the instruction step is indicated.

In at least one embodiment, an expertise level of each instruction step may be scored and/or a score may be adjusted based on usage of the instruction step for different levels. In at least one implementation, a document that provides instruction steps in answer to a question (directed to achieving a task or a sub-task) is annotated (e.g., using metadata in a markup language) as to a knowledge level that requires the steps. The markup language may be configured such that a lower level of understanding (e.g., novice) requires additional steps or sub-steps than a higher level of understanding (e.g., expert). As one example, an answer to the question “How do I open the door?” may be given based on an expertise level of a user as follows:

<novice>Walk to the door</novice>
<novice>Grab the door knob</novice>
<intermediate>Turn the door knob until it stops</intermediate>
<expert>Pull the door open</expert>

In the above example, a user identified at a novice level is presented with all four steps, a user identified at an intermediate level is presented with the final two steps, and a user identified at an expert level is presented with only the last step.

As another example, an answer to the question “How do I update my mobile phone?” may be given based on an expertise level of a user as follows:

<novice/intermediate> 1. Plug in your device to a power source.
<novice> 2. Connect to Wi-Fi.

<novice> a. Tap settings
<novice> b. Wi-Fi
<novice> c. Choose and tap Wi-Fi connection

<novice/intermediate/expert> 3. Navigate to Software Update (Tap

Settings−>General−>Software Update)

<novice> a. Tap Settings
<novice> b. Scroll, find and tap General
<novice> c. Scroll and tap Software Update.
<novice> d. Now you are on the Settings−>General−>Software
Update section.

<novice/intermediate/expert>4. Tap Download and Install to
download the update.
<novice/intermediate/expert>5. Tap Install when the download
completes.
<novice/intermediate> 6. If your device is passcode enabled, it will

ask you to enter the passcode before installing the update.

In the above example, occurrences of the steps located in searched information may also be annotated with various conditionality type descriptors (e.g., optional, required, or normal) based on text analysis. For example, terms such as ‘if’, ‘must’, ‘required’, ‘prerequisite’, etc. may be located in the searched information and the occurrences in the searched information may be counted and linked to the steps or sub-steps. A step may, for example, be denoted as a main step, if the step includes sub-steps or may be referred to as a goal or a result of a series of pre-steps. Occurrences of the same repeated sets of instructions steps may then be located in the searched information and statements may then be reduced to their simplest forms (e.g., lemma, synonym, and sentence structure). A main step that includes a series of sub-steps is then designated as such in the information. The associated sub-steps are then assigned an initial expertise level, e.g., based on a number of occurrences.

In one embodiment, the most frequent repetitive instruction steps labeled ‘normal’, ‘required’, or ‘optional’ are designated as novice (e.g., eighty-five percent or above a maximum occurrence). A next level of repeated instructions steps, e.g., labeled ‘normal’ or ‘required’, may be designated as intermediate (e.g., forty to eighty-four percent of the maximum occurrence). A next level of repeated instruction steps labeled as ‘required’ may be designated as expert. For example, expert level main steps may be: required steps; low occurrence main steps (e.g., less than ten percent of the maximum occurrence); or designated as a ‘prerequisite’. In one or more embodiments, instruction steps, instruction sub-steps, and tasks are annotated with cross-references. Based on the instruction steps to achieve a task, the instruction steps and sub-steps, an associated expertise level, and associated metadata (e.g., required, normal, optional, prerequisite) are provided to a client (i.e., a data processing system associated with a user). The client may then display instruction steps and sub-steps to achieve an associated task (with an indicator, such as ‘novice’, ‘intermediate’, or ‘expert’) for each of the steps and sub-steps based on an expertise level of the user.

As a user expands sections that are at a lower expertise level, a QA system may learn from the expansion and use the expansion to adjust expertise level metadata within the searched information. Various techniques may be used to perceive the expertise level of a user asking a question. For example, an expertise level of a user may be based on a query language the user employs. As one example, a QA system may note whether a user: employs more technical language to ask a question; and/or uses abbreviations or other shorthand that are known by people more familiar with a topic. As another example, a user profile may be accessed that includes information indicating an expertise level of a user and/or social activities of a user may be searched to determine an expertise level of the user. For example, if a user is a prolific blogger in a given field a user may be considered to be an expert in the given field. As yet another example, if a user is absent from online social conversations in a given field, the user may be considered to be a novice in the given field. As another example, a user query history with a QA system may also be analyzed to determine what areas of questions the person has previously asked to derive a perceived expertise level for the user.

It should be appreciated that an expertise level of a user can also be initially defined by the user, discovered by a QA system through previous use of the QA system by the user, or during a current user interaction with the QA system. Based on the QA system determining a expertise level for a user, appropriate steps that have been rated for an appropriate expertise level are then presented to the user. If the user is at a novice level, the user is presented with all steps to perform an associated task. If the user is at an intermediate level, only those steps for an intermediate level and above are presented to the user. In one or more embodiments, a level appropriate set of steps are presented to the user, with an option to retrieve a lower level set of steps dynamically for display to the user (or a customer service representative that is in communication with the user), as required. For example, the step expertise designation (e.g., novice, intermediate, expert) may be displayed to a customer service representative or a user during training to fine tune the QA system.

Steps may be further delineated as novice, intermediate, or expert based on user feedback. For example, if a user identified by a QA system as an intermediate level user provides feedback that the intermediate level steps are not sufficient for the user to perform an associated task, the QA system may present novice instructions to the user. The user may then identify which additional steps were required and the QA system may then designate the instructions that were previously marked as ‘novice’ as candidates to become marked as ‘intermediate’ instructions (i.e., an ‘intermediate’ user requires the particular instructions previously marked as ‘novice’). Re-designating an instruction or set of instructions may be initiated based on feedback on the instructions exceeding, for example, a user configurable threshold level (e.g., when a specific percentage of ‘intermediate’ users over time have the same problem then the steps may be changed from ‘novice’ to ‘intermediate’).

In various embodiments, based on user feedback, when a number of users at a given expertise level require additional sub-steps for a task, the step is changed to the expertise level of the users. For example, when a number of ‘intermediate’ level users that require additional instruction sub-steps to achieve a task reaches a threshold (e.g., based on a total number of users at that level) the expertise level of the sub-steps is changed from ‘novice’ to ‘intermediate’. In one embodiment, the number of users requiring the additional sub-steps is scored against the initial designation to determine whether the level should be adjusted. Scoring may be based, for example, on: a conditionality type (e.g., optional, required, normal); a prerequisite (yes or no); a number of users accessing additional steps; occurrences of steps; and/or a number of sub-steps needed to complete a task. Additionally, a QA system may (in addition to discerning knowledge of a user) determine difficulty with language based on a criteria used to determine expertise. In one or more embodiments, metadata that identifies an expertise level of specific steps may be extended to denote where the steps can be broken up. As one example, ‘stop and sit down’ may be broken up into ‘stop’ and ‘sit down’.

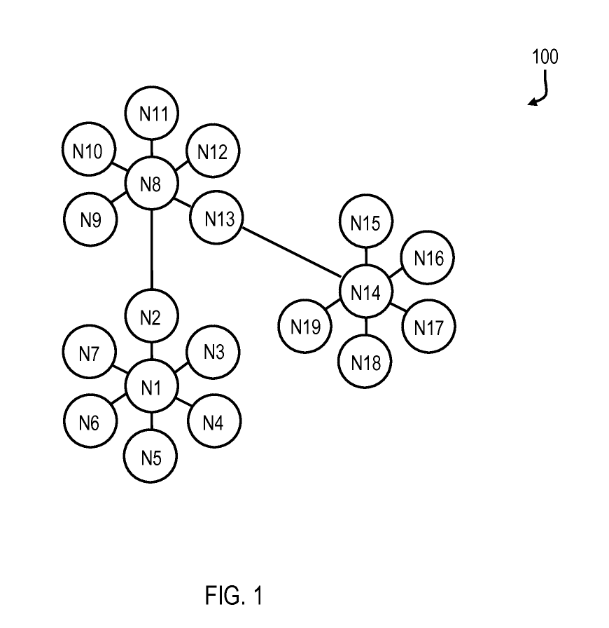

According to various aspects of the present disclosure, techniques for performing high performance computing (HPC), or network computing, are described herein that facilitate answering user questions based on user expertise level. An HPC may, for example, include multiple nodes, each of which may include one or more symmetric multiprocessors (SMPs). With reference to FIG. 1, an example topology for a relevant portion of an exemplary HPC cluster (supercomputer) 100 includes a number of nodes (N1-N18) that are connected in, for example, a three-dimensional (3D) Torus topology. While eighteen nodes are illustrated in FIG. 1, it should be appreciated that more or less than eighteen nodes may be present in an HPC cluster configured according to the present disclosure.

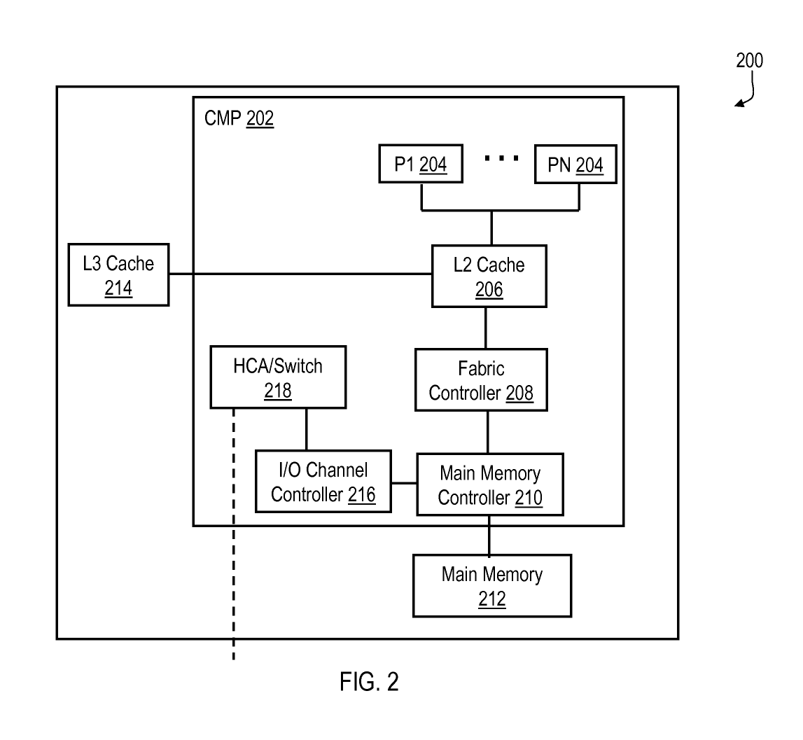

With reference to FIG. 2, each of the nodes N1-N18 of FIG. 1 may include a processor system, such as data processing system 200. As is illustrated, data processing system 200 includes one or more chip-level multiprocessors (CMPs) 202 (only one of which is illustrated in FIG. 2), each of which includes multiple (e.g., eight) processors 204. Processors 204 may, for example, operate in a simultaneous multithreading (SMT) mode or a single thread (ST) mode. When processors 204 operate in the SMT mode, processors 204 may employ multiple separate instruction fetch address registers to store program counters for multiple threads.

In at least one embodiment, processors 204 each include a first level (L1) cache (not separately shown in FIG. 2) that is coupled to a shared second level (L2) cache 206, which is in turn coupled to a shared third level (L3) cache 214. The L1, L2, and L3 caches may be combined instruction and data caches or correspond to separate instruction and data caches. In the illustrated embodiment, L2 cache 206 is further coupled to a fabric controller 208 that is coupled to a main memory controller (e.g., included in a Northbridge) 210, which supports a main memory subsystem 212 that, in various embodiments, includes an application appropriate amount of volatile and non-volatile memory. In alternative embodiments, fabric controller 208 may be omitted and, in this case, L2 cache 206 may be directly connected to main memory controller 210.

Fabric controller 208, when implemented, facilitates communication between different CMPs and between processors 204 and memory subsystem 212 and, in this manner, functions as an interface. As is further shown in FIG. 2, main memory controller 210 is also coupled to an I/O channel controller (e.g., included in a Southbridge) 216, which is coupled to a host channel adapter (HCA)/switch block 218. HCA/switch block 218 includes an HCA and one or more switches that may be utilized to couple CMP 202 to CMPs in other nodes (e.g., I/O subsystem nodes and processor nodes) of HPC cluster 100.

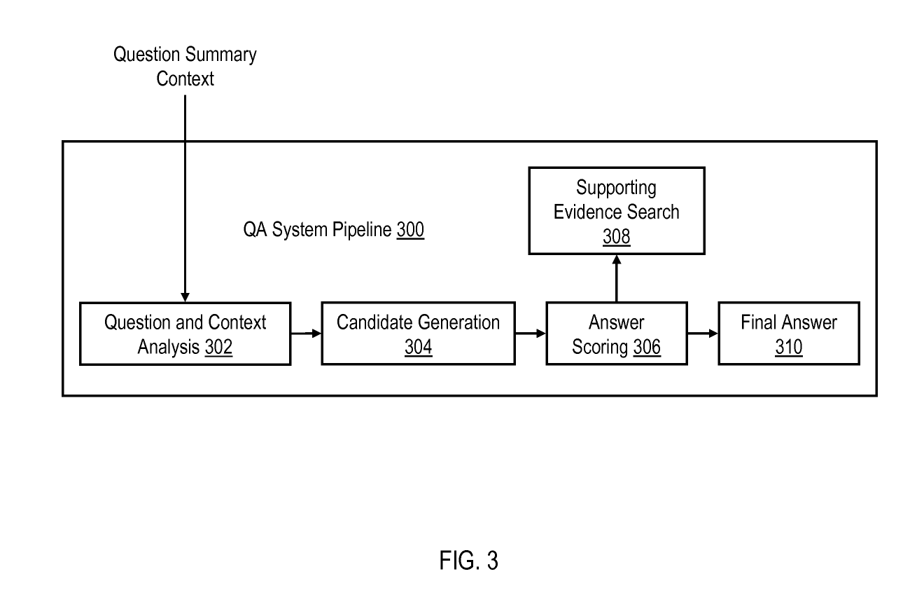

FIG. 3 illustrates relevant components of a QA system pipeline for an exemplary QA system. As is illustrated in FIG. 3, a question and context analysis block 302 of QA system pipeline 300 receives a question (e.g., in the form of a question summary context) as an input and generates an output representing its analysis of the question and the context of the question. A candidate generation block 304 of QA system pipeline 300 receives the output from question and context analysis block 302 at an input and generates candidate answers (e.g., including instruction steps and/or instruction sub-steps) for the question. The candidate answers are provided to an input of an answer scoring block 306, which is configured to initiate a supporting evidence search (by supporting evidence search block 308) in order to score the various generated answers. The results of the answer scoring are provided to a final answer block 310, which is configured to provide a final answer (e.g., including one or more instruction steps and/or one or more instruction sub-steps) to the question based on the scoring of the candidate answers. It should be appreciated that blocks 302-310 may be implemented in program code executing on one or more processor cores or may be directly implemented in dedicated hardware (logic).

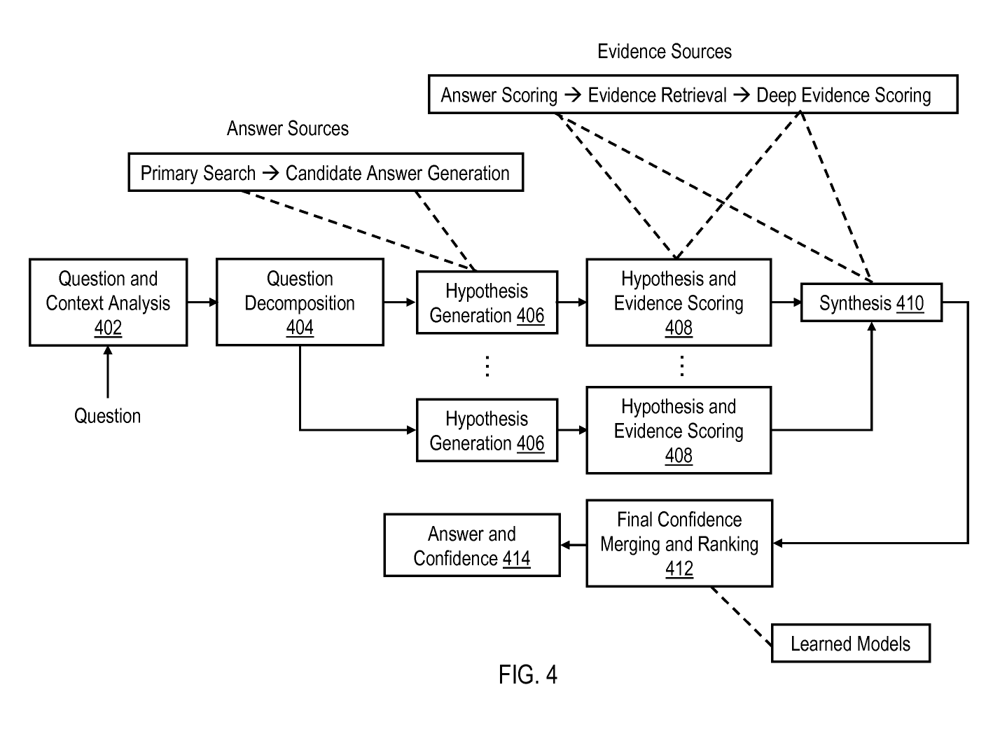

FIG. 4 illustrates relevant components of an exemplary QA system pipeline in additional detail. As is illustrated, question and analysis context block 402 receives a question in a natural language. An output of block 402 is provided to a question decomposition block 404, which further analyzes the different textual, grammatical, linguistic, punctuation and/or other components of the question. Block 404 provides inputs to multiple hypothesis generation blocks 406, which perform parallel hypothesis generation. Hypothesis generation blocks 406 each perform a primary search, collect reference data from different structured and unstructured sources, and generate candidate answers. For example, data generated by hypothesis ‘i’ may be referenced as ‘D_i’, and data generated by hypothesis ‘j’ may be referenced as ‘D_j’. The data ‘D_i’ and ‘D_j’ may be the same data, completely different data, or may include overlapping data.

As one example, a QA system may be configured, according to the present disclosure, to: receive a question; create ‘N’ hypotheses (1 . . . N) to find candidate answers (e.g., N=10); and load data for each hypothesis ‘i’ on which to operate into a shared cache. For example, assuming a shared cache across all hypotheses, 1/Nth of the shared cache may be loaded with data for each hypothesis to operate on. The QA system may be further configured to execute the ‘N’ hypotheses to return ‘M’ candidate answers (in this case, each hypothesis generates one or more candidate answers). For example, the notation ‘ANS_i’ may be employed to denote a set of candidate answers generated by hypothesis ‘i’. In various embodiments, hypothesis and evidence scoring for each hypothesis is initiated in hypothesis and evidence scoring blocks 408. That is, the QA system is further configured to score all the candidate answers using hypothesis and evidence scoring techniques (e.g., providing ‘M’ scores for ‘M’ candidate answers). In synthesis block 410 the QA system evaluates the candidate answers with the highest scores and determines which hypotheses generated the highest scores.

Following block 410, the QA system initiates final confidence merging and ranking in block 412. Finally, in block 414, the QA system provides an answer (and may provide a confidence score) to the question. Assuming, for example, the candidate answers T, ‘k’, and ‘l’ have the highest scores, a determination may then be made as to which of the hypotheses generated the best candidate answers. As one example, assume that hypotheses ‘c’ and ‘d’ generated the best candidate answers ‘j’, ‘k’, and ‘l’. The QA system may then upload additional data required by hypotheses ‘c’ and ‘d’ into the cache and unload data used by other hypotheses from the cache. According to the present disclosure, the priority of what data is uploaded is relative to candidate scores (as such, hypotheses producing lower scores have less associated data in cache). When a new question is received, the above-described process is repeated. If the hypotheses ‘c’ and ‘d’ again produce best candidate answers, the QA system may load more data that is relevant to the hypotheses ‘c’ and ‘d’ into the cache and unload other data.

If, on the other hand, hypotheses ‘h’ and ‘g’ produce the best candidate answers to the new question, the QA system may load more data relevant to the hypotheses ‘h’ and ‘g’ into the cache and unload other data. It should be appreciated that, at this point, hypotheses ‘c’ and ‘d’ probably still have more data in the cache than other hypotheses, as more relevant data was previously loaded into the cache for the hypotheses ‘c’ and ‘d’. According to the present disclosure, the overall process repeats in the above-described manner by basically maintaining data in the cache that answer and evidence scoring indicates is most useful. The disclosed process may be unique to a QA system when a cache controller is coupled directly to an answer and evidence scoring mechanism of a QA system.

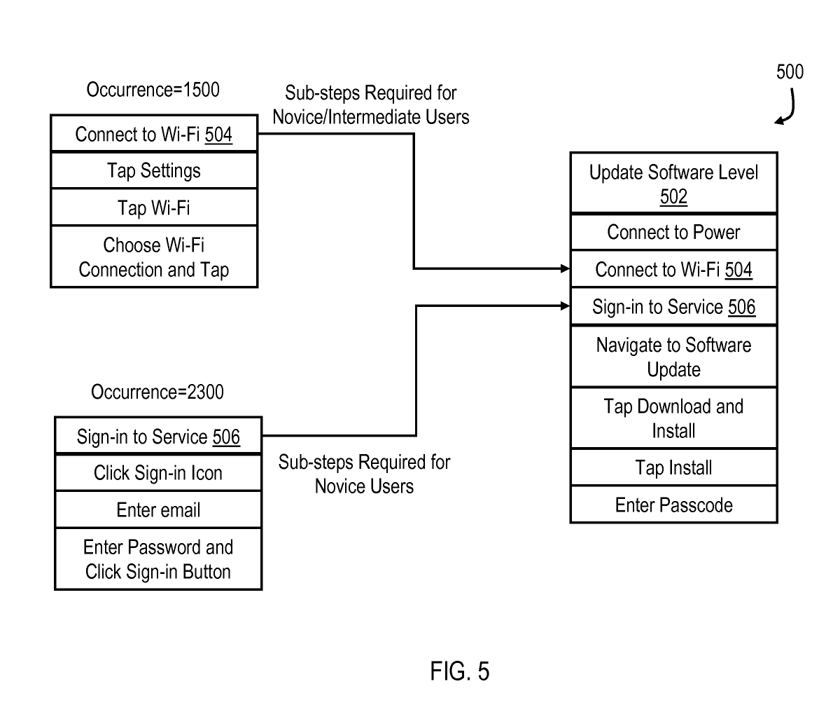

With reference to FIG. 5, a diagram 500 illustrates exemplary instruction steps for updating a software level of a mobile phone based on user expertise. As is illustrated in diagram 500, the seven main steps to update software level 502 include: connect to power; connect to Wi-Fi 504; sign-in to service 506; navigate to software update; tap download and install; tap install; and enter passcode. As is also illustrated in FIG. 5, the main step ‘Connect to Wi-Fi’ 504 (which is labeled ‘Occurrence=1500’, meaning the main step was found in loaded information fifteen hundred times) includes three sub-steps: ‘tap settings’; ‘tap Wi-Fi’, and ‘choose Wi-Fi connection and tap’. As is noted, the sub-steps for the main step ‘connect to Wi-Fi’ 504 are required for ‘novice’ and ‘intermediate’ users. In this case, the sub-steps associated with the step ‘connect to Wi-Fi’ 504 are not presented to expert users. As is further illustrated in diagram 500, the main step ‘sign-in to service’ 506 (which is labeled ‘Occurrence=2300’, meaning the main step was found in loaded information twenty-three hundred times) also includes three sub-steps: ‘click sign-in icon’; ‘enter email’; and ‘enter password and click sign-in button’. As is noted, the sub-steps for the main step ‘sign-in to service’ 506 are required for ‘novice’ users. In this case, the sub-steps associated with the main step ‘sign-in to service’ 506 are not presented to ‘intermediate’ and ‘expert’ users. It should be appreciated that the techniques disclosed herein may be applied to tasks that require more or less than seven main steps and the each main step may be broken into more or less than three sub-steps.

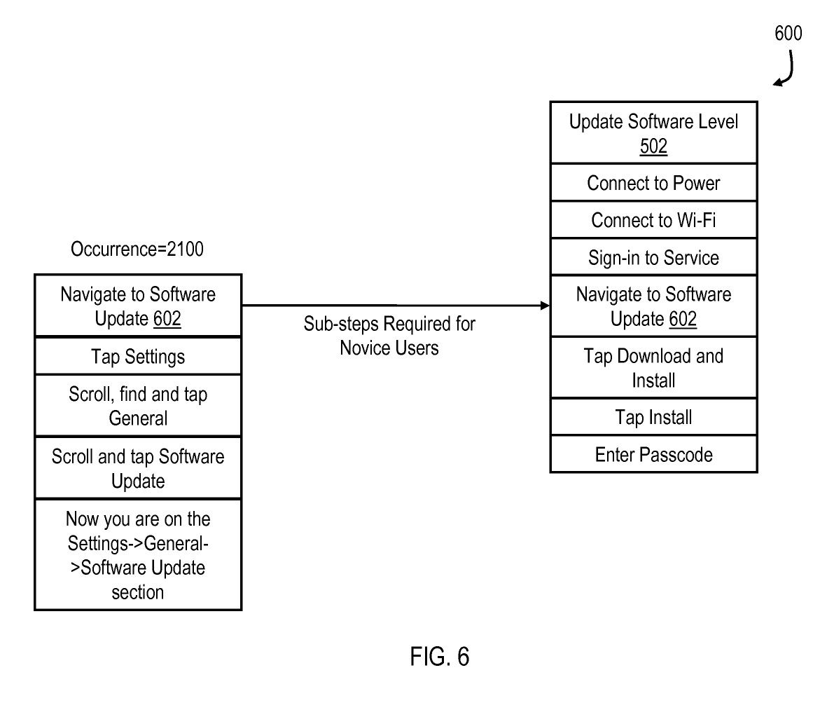

With reference to FIG. 6, a diagram 600 further illustrates exemplary steps for updating a software level of a mobile phone based on user expertise. As is illustrated in diagram 600, the seven main steps to update software level 502 include: connect to power; connect to Wi-Fi; sign-in to service; navigate to software update; tap download and install; tap install; and enter passcode. As is also illustrated in FIG. 5, the main step ‘Navigate to Software Update’ 602 (which is labeled ‘Occurrence=2100’, meaning the main step was found in loaded information twenty-one hundred times) includes four sub-steps: ‘Tap Settings’; ‘Scroll, Find and Tap General’; ‘Scroll and Tap Software Update’; and Now you are on the Settings->General->Software Update Section′. As is noted, the sub-steps for the main step ‘Navigate to Software Update’ 602 are required for ‘novice’ users. In this case, the sub-steps associated with the step ‘Navigate to Software Update’ 602 would not be presented to ‘expert’ or ‘intermediate’ users. It should be appreciated that the techniques disclosed herein may be applied to tasks that require more or less than seven main steps and the each main step may be broken into more or less than four sub-steps.

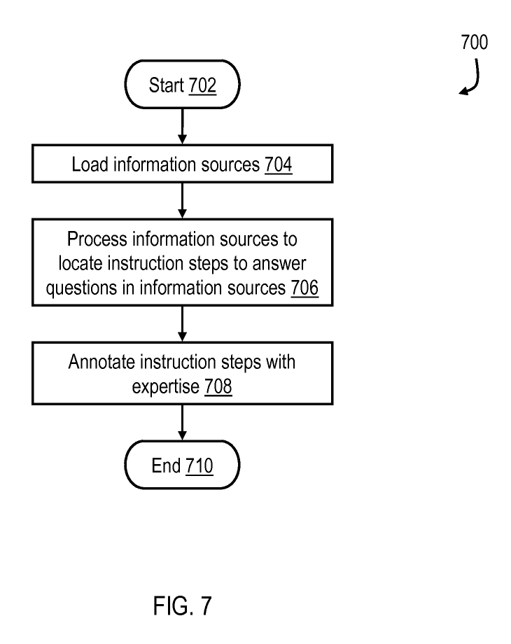

With reference to FIG. 7, a process 700 for processing information sources for answering user questions based on user expertise level, according to aspects of the present disclosure, is illustrated. Process 700 may be implemented, for example, through the execution of one or more program modules (that are configured to function as a user expertise level analysis engine) by one or more processors 204 of data processing system 200.

Process 700 may, for example, be initiated in block 702 in response to receiving a user request to load designated information sources to answer questions for a particular topic (area) into data processing system 200. It should be appreciated that information sources may be directed to virtually any topic (e.g., healthcare, banking, geography, information technology, etc.). The topic may, for example, be determined using natural language processing. Next, in block 704, data processing system 200 loads the information sources. Then, in block 706, data processing system 200 processes the information sources to locate instructions steps and sub-steps (to answer questions) in the information sources. According to one or more embodiments, a set of documents for a domain (topic) is parsed to locate instruction steps and sub-steps to perform a desired task. Data processing system 200 may also annotate the instruction steps (e.g., add metadata related to an importance type of the steps, such as mandatory, optional, explanatory, and basic). In at least one embodiment, all instructions steps and sub-steps for a given task are annotated. Relevant available information may then be searched for similar steps and to determine how often the steps are repeated in the information. A determination may then be made as to which steps are ‘optional’ or ‘conditional’ via statement analysis (e.g., language such as ‘optional’, ‘if’, ‘prerequisite’, etc.), which steps are required (including language such as ‘make sure’, ‘must’, ‘always’, etc.), and the steps may then be annotated accordingly. Instruction steps that achieve a sub-task (i.e., a main step of a task) may be determined by noting repetition of the instruction steps that achieve the sub-task within the information.

Then, in block 708, data processing system 200 assigns expertise levels (e.g., novice, intermediate, or expert) to the steps and sub-steps to indicate an expertise level for the steps and sub-steps. An expertise level (e.g., novice, intermediate, expert) may be designated based on, for example, conditionality type descriptors (e.g., optional, required, or normal) and whether the item is a step or a sub-step. In one embodiment, the designation of expertise level is based on the number of occurrences and prevalence of particular instruction steps in searched information or a sub-category of the searched information. In general, as the number of occurrences of a given instruction step increases, a lower expertise level for the given instruction step is indicated. In at least one embodiment, an expertise level of each instruction step may be scored and/or a score may be adjusted based on usage of the instruction step for different levels. In at least one implementation, a document that provides instruction steps in answer to a question (directed to achieving a task or a sub-task) is annotated (e.g., by metadata using a mark-up language) as to a knowledge level that requires the steps. The mark-up language may be configured such that a lower level of understanding (e.g., novice) requires additional steps or sub-steps than a higher level of understanding (e.g., expert). Following block 708 process 700 terminates in block 710 until, for example, a next request to load information sources is received.

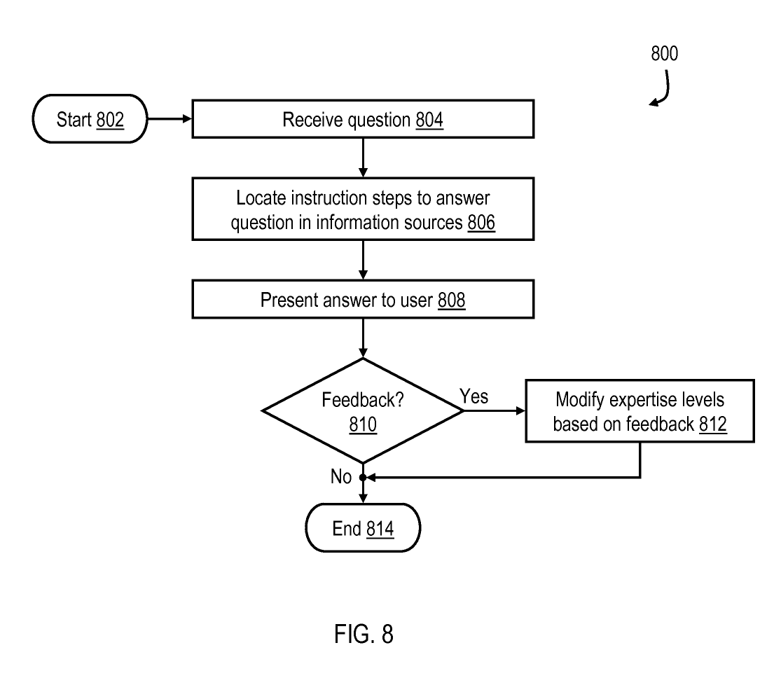

With reference to FIG. 8, a process 800 for answering user questions based on user expertise level, according to aspects of the present disclosure, is illustrated. Process 800 may be implemented, for example, through the execution of one or more program modules (that are configured to function as a user expertise level analysis engine) by one or more processors 204 of data processing system 200.

Process 800 may, for example, be initiated in block 802 in response a user initiating a question answering session with data processing system 200. It should be appreciated that a question may be directed to virtually any question type or question area (e.g., healthcare, banking, geography, information technology, etc.). Then, in block 804 data processing system 200 receives a question from the user. For example, a received question may be analyzed to determine various characteristics or factors, e.g., question type (e.g., human, disease, cancer, lung), evidence size associated with the question type, and characteristics of the question (e.g., primary search attributes and how often the same question type is received). Based on the analysis, multiple hypotheses for the received question may then be generated and evidence for each of the hypotheses may be loaded into L2 cache 206. One or more candidate answers may be generated for each of the hypotheses, based on the evidence loaded into L2 cache 206. The candidate answers may then be scored in a conventional manner. Next, in block 806, data processing system 200 locates instructions steps and sub-steps to answer the received question within associated information sources. Then, in block 808, data processing system 200 presents the highest scored answer (e.g., in the form of a series of steps that may include a number of sub-steps for each step).

Next, control transfers from block 808 to decision block 810, where data processing system 200 determines whether user feedback has been received. For example, user feedback may take the form of a user requesting additional sub-steps for a step. As one example, if a user identified as an expert level user provides feedback that the expert level steps are not sufficient for the user to perform an associated task, data processing system 200 may present intermediate level instructions to the user. The user may then identify which additional steps were required and data processing system 200 may then designate the instructions that were previously marked as ‘intermediate’ as candidates to become marked as ‘expert’ instructions (i.e., an expert user requires the particular instructions previously marked as ‘intermediate’). Re-designating an instruction or set of instructions may be initiated based on feedback on the instructions exceeding, for example, a user configurable threshold level (e.g., when a specific percentage of expert users over time have the same problem then the steps may be changed from ‘intermediate’ to ‘expert’). In response to feedback not being received for a predetermined time period in block 810, control transfers to block 814 where process 800 terminates until a next question is received. In response to feedback being received within the predetermined time period in block 810, control transfers to block 812 where data processing system 200 modifies an expertise level of one or more steps and/or sub-steps based on the feedback. Following block 812 control transfers to block 814.

Accordingly, techniques have been disclosed herein that advantageously answer user questions based on user expertise level.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

1.-8. (canceled)

9. A computer program product for responding to user questions, the computer program product comprising:
a computer-readable storage device; and
computer-readable program code embodied on the computer-readable storage device, wherein the computer-readable program code, when executed by a data processing system, causes the data processing system to:
determine an expertise level of a user with a topic of a question presented by the user to the data processing system; and
generate an answer to the question that is based on the expertise level of the user with the topic.

10. The computer program product of claim 9, wherein the computer-readable program code, when executed by the data processing system, further causes the data processing system to:
receive the question from the user; and
apply natural language processing to the question to determine the topic of the question.

11. The computer program product of claim 9, wherein the computer-readable program code, when executed by the data processing system, further causes the data processing system to:
annotate information utilized in the answer with conditionality type descriptors.

12. The computer program product of claim 11, wherein the conditionality type descriptors include normal, mandatory, required, optional, explanatory, prerequisite, and basic.

13. The computer program product of claim 11, wherein the computer-readable program code, when executed by the data processing system, further causes the data processing system to:
adjust selected ones of the conditionality type descriptors and/or an expertise level for an instruction step or sub-step in the annotated information based on feedback from the user.

14. The computer program product of claim 9, wherein the computer-readable program code, when executed by the data processing system, further causes the data processing system to:
modify the expertise level of the user based on feedback received from the user, wherein the feedback is based on one or more of the user expanding instruction steps in the answer that are at a lower expertise level than currently assigned to the user, a query language utilized by the user in the question, a profile of the user, online activities of the user, and a query history of the user with the data processing system, and wherein the answer includes instruction steps for performing a task associated with the question.

15. A data processing system, comprising:
a cache memory; and
a processor coupled to the cache memory, wherein the processor is configured to:
determine an expertise level of a user with a topic of a question presented by the user to the data processing system; and
generate an answer to the question that is based on the expertise level of the user with the topic.

16. The data processing system of claim 15, wherein the processor is further configured to:
receive the question from the user; and
apply natural language processing to the question to determine the topic of the question.

17. The data processing system of claim 16, wherein the processor is further configured to:
annotate information utilized in the answer with conditionality type descriptors.

18. The data processing system of claim 17, wherein the conditionality type descriptors include normal, mandatory, required, optional, explanatory, prerequisite, and basic.

19. The data processing system of claim 17, wherein the processor is further configured to:
adjust selected ones of the conditionality type descriptors and/or an expertise level for an instruction step or sub-step in the annotated information based on feedback from the user.

20. The data processing system of claim 15, wherein the processor is further configured to:
modify the expertise level of the user based on feedback received from the user, wherein the feedback is based on one or more of the user expanding instruction steps in the answer that are at a lower expertise level than currently assigned to the user, a query language utilized by the user in the question, a profile of the user, online activities of the user, and a query history of the user with the data processing system, and wherein the answer includes instruction steps for performing a task associated with the question.
